(19) United States
(12) Patent Application Publication
(10) Pub. No.: US 2019/0025602 A1
(43) Pub. Date: Jan. 24, 2019

(54) COMPACT NEAR-EYE DISPLAY OPTICS FOR AUGMENTED REALITY

(71) Applicant: Google LLC, Mountain View, CA (US)

(72) Inventors: Yi QIN, Mountain View, CA (US); Serge BIERHUIZEN, Mountain View, CA (US); Xinda HU, Mountain View, CA (US); Jerome CAROLLO, Mountain View, CA (US)

(21) Appl. No.: 15/935,751

(22) Filed: Mar. 26, 2018

Related U.S. Application Data
(60) Provisional application No. 62/534,939, filed on Jul. 20, 2017.

(51) Int. Cl. G02B 27/22; G02B 27/28; G02B 27/12; G02B 5/30

(52) U.S. Cl. CPC G02B 27/2242; G02B 27/286; G02B 5/3083; G02B 5/3025; G02B 27/123

(57) ABSTRACT

An optical system includes a first filter stack configured to convert light received from a display to a first circular polarization, a second filter stack configured to convert light received from external sources to a second circular polarization, and a third filter stack configured to reflect light having the first circular polarization and transmit light having the second circular polarization. The optical system also includes a refractive beam splitting lens configured to transmit light received from the second filter stack to the third filter stack. The second filter stack is oriented to reflect light received from the first filter stack onto the refractive beam splitting lens. The optical system is implemented in augmented reality devices, such as head mounted devices (HMDs), to combine images generated by the display with light received from external sources.

### BACKGROUND

Augmented reality (AR) systems typically utilize a head mounted display (HMD) device that focuses light rays received from the environment and light rays generated by a display onto the eyes of a user. A user wearing the HMD device therefore views a scene of the real world that is “augmented” with virtual images. For example, an HMD device can augment the user's view of an unfamiliar street by overlaying a virtual image including walking directions. The optical system implemented in an HMD that supports AR functionality typically includes a beam splitting element that transmits external light to the user's eyes and reflects light from the display into the path of the external light, as well as an optical element to focus light onto the user's eyes. Several designs of HMD devices that provide AR functionality are currently available. The optical systems implemented in these HMD devices include birdbath optics (a concave mirror and a display separated by a beam splitter that combines the virtual image with the see-through image), a display coupled into a (geometric or diffractive) waveguide by a collimation lens, a display coupled to multiple freeform reflectors, and a display coupled to a freeform prism.

These optical systems share a common deficiency: the element that provides optical power (e.g., focusing of the light rays) is positioned relatively far from the user's eyes, which reduces the field-of-view of the virtual image. For example, a typical field-of-view for a conventional AR system is around 25°. The field-of-view can be increased by increasing the size of the AR system, but this is undesirable in a wearable HMD device. Furthermore, some of the optical systems distort the see-through image. For example, a geometrical waveguide that uses total internal reflection to guide the virtual image to the user's eyes can generate segmented shadows in the see-through image. For another example, a diffractive waveguide that uses diffraction to guide the virtual image to the user's eyes can generate ghost images from unwanted diffraction orders. For yet another example, a freeform prism can create non-uniform see-through distortion that causes eyestrain.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram of a first example of an optical system that combines light received from a display with external light to provide substantially parallel light rays that represent an augmented reality image to an eye of a user according to some embodiments.

FIG. 2 is a diagram of a second example of an optical system that illustrates folding of an optical path of a light ray generated by a display and combination of the light ray with external light according to some embodiments.

FIG. 3 is a diagram of a third example of an optical system that combines light received from a display with external light to provide substantially parallel light rays that represent an augmented reality image to an eye of a user according to some embodiments.

FIG. 4 is a diagram of a fourth example of an optical system that combines light received from a display with external light to provide substantially parallel light rays that represent an augmented reality image to an eye of a user according to some embodiments.

FIG. 5 is a diagram of a fifth example of an optical system that combines light received from a display with external light to provide substantially parallel light rays that represent an augmented reality image to an eye of a user according to some embodiments.

FIG. 6 is a comparison of a conventional birdbath lens system and a lens system that includes a refractive beam splitting lens system according to some embodiments.

FIG. 7 illustrates a display system that includes an electronic device configured to provide augmented reality functionality via a display according to some embodiments.

### DETAILED DESCRIPTION

An optical system that provides an increased field-of-view (e.g., on the order of) 80° for applications such as augmented reality (AR), while encompassing a significantly smaller volume than conventional AR optical systems, includes a first filter stack configured to convert light received from a display to a first circular polarization, a second filter stack configured to convert light received from external sources to a second circular polarization, and a third filter stack configured to reflect light having the first circular polarization and transmit light having the second circular polarization. The optical system also includes a refractive beam splitting convex lens configured to transmit light received from the second filter stack to the third filter stack. The second filter stack is oriented to reflect light received from the first filter stack onto the refractive beam splitting convex lens.

Some embodiments of the first filter stack include a linear polarizer to convert light to a first linear polarization and a quarter wave plate to convert the light from the first linear polarization to the first circular polarization. Some embodiments of the second filter stack include a quarter wave plate to convert the first circular polarization to the first linear polarization and a polarization dependent beam splitter to reflect light having the first linear polarization while transmitting light having a second linear polarization. Some embodiments of the third filter stack include a quarter wave plate and a polarization dependent beam splitter configured to reflect light having the first linear polarization and transmit light having the second linear polarization. In some embodiments, the refractive beam splitting convex lens is plano-convex and the optical system includes a plano-concave lens. A concave curvature of the plano-concave lens is matched to the convex curvature of the plano-convex lens. The convex surface of the plano-convex lens can be joined to the concave surface of the plano-concave lens or the third filter stack can be deployed between the planar surfaces of the plano-convex lens and the plano-concave lens.

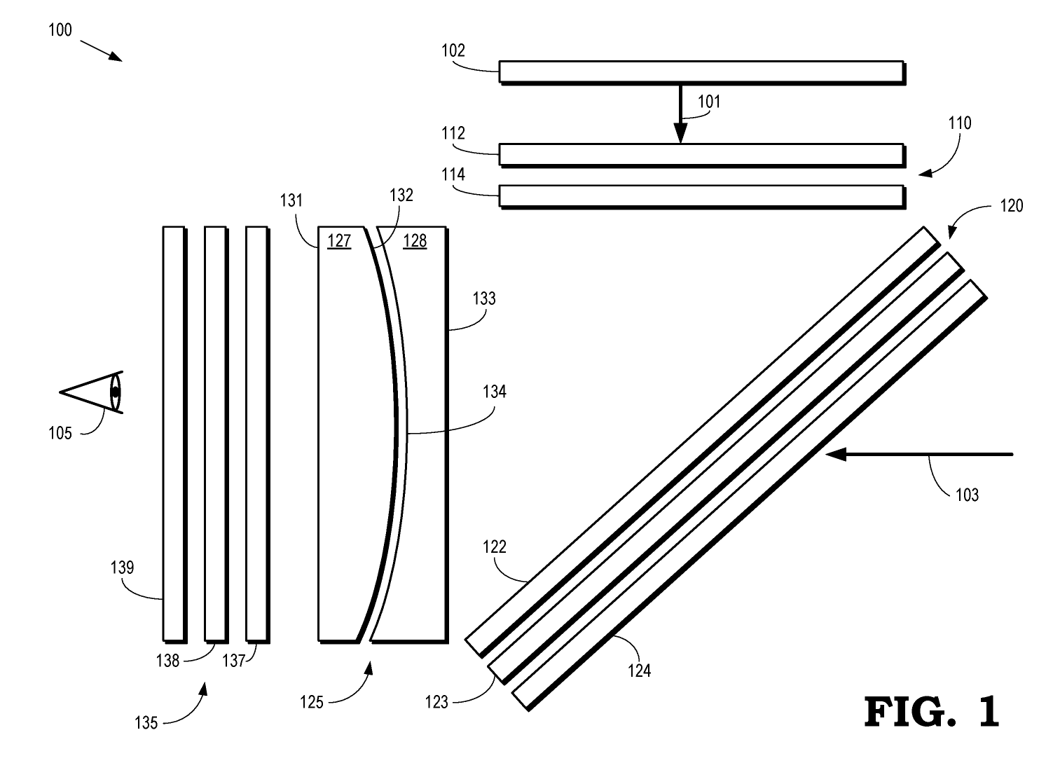

FIG. 1 is a diagram of a first example of an optical system 100 that combines light 101 received from a display 102 with external light 103 to provide substantially parallel light rays that represent an augmented reality image to an eye 105 of a user according to some embodiments. The optical system 100 includes a first filter stack 110 that receives light from the display 102. Some embodiments of the filter stack 110 include a linear polarizer 112 that converts the received light 101 to a first linear polarization. For example, the linear polarizer 112 can convert unpolarized (or partially polarized) light to light that is polarized in a direction that is parallel to the longer dimension of the linear polarizer 112 as shown in FIG. 1, which is referred to herein as the y-direction. The filter stack 110 also includes a quarter wave plate 114 that converts linear polarized light into a first circular polarization. For example, the quarter wave plate 114 can convert light polarized in the y-direction to right circularly polarized light. Some embodiments of the filter stack 110 are integrated with the display 102. For example, the linear polarizer 112 can be laminated to a surface of the display 102. However, in other embodiments, the first filter stack 110 is separated from the display 102 by an air gap.

The optical system 100 includes a second filter stack 120 that transmits light having a first polarization and reflects light having a second polarization that is orthogonal to the first polarization. For example, the second filter stack 120 can be configured to transmit light having left circular polarization and reflect light having right circular polarization. The second filter stack 120 includes a quarter wave plate 122 that converts circularly polarized light into linearly polarized light. For example, the quarter wave plate 122 can convert right circularly polarized light into light that is polarized in the y-direction and the quarter wave plate 122 can convert left circularly polarized light into light that is polarized in a direction perpendicular to the plane of the drawing, which is referred to herein as the x-direction and which is orthogonal or transverse to the y-direction. The second filter stack 120 also includes a polarization dependent beam splitter 123 that transmits light polarized in a first direction and reflects light polarized in a second direction that is orthogonal or transverse to the first direction. For example, the polarization dependent beam splitter 123 can reflect light polarized in the y-direction and transmit light polarized in the x-direction. Some embodiments of the second filter stack 120 also include a linear polarizer 124 that transmits linearly polarized light. For example, the linear polarizer 124 can transmit light polarized in the x-direction, while filtering out light polarized in the y-direction.

The optical system 100 also includes a refractive beam splitting lens system 125. Examples of a refractive beam splitting lens system 125 are described in U.S. Provisional Patent Application Ser. No. 62/531,225, which is incorporated herein by reference in its entirety. Some embodiments of the refractive beam splitting lens system 125 include a refractive plano-convex lens 127 and a refractive plano-concave lens 128. The refractive plano-convex lens 127 includes a planar surface 131 that is opposite to a convex surface 132. The refractive plano-convex lens 127 is formed of a material having a first refractive index and a beam splitting coating is applied to the convex surface 132. For example, the refractive plano-convex lens 127 can be formed of glass or plastic and the convex surface 132 can be a half-silvered surface. The refractive plano-concave lens 128 includes a planar surface 133 that is opposite to a concave surface 134. The refractive plano-concave lens 128 can be formed of glass or plastic that has a second refractive index that is the same or different from the first refractive index. The curvature of the concave surface 134 is complementary to the curvature of the convex surface 132, e.g., the curvatures can be matched. Although a small separation is shown between the refractive plano-convex lens 127 and the refractive plano-concave lens 128, the two lenses are in contact with each other in some embodiments of the optical system 100. Some embodiments of the refractive beam splitting lens system 125 have a focal length in the range of 150 mm to 300 mm. For example, the focal length of the refractive beam splitting lens system 125 can be within the range of 180 mm to 280 mm.

The optical system 100 includes a third filter stack 135 that transmits light having a first polarization and reflects light having a second polarization that is orthogonal to the first polarization. For example, the third filter stack 135 can be configured to transmit light having left circular polarization and reflect light having right circular polarization. Some embodiments of the third filter stack 135 include a quarter wave plate 137 that converts circularly polarized light into linearly polarized light. For example, the quarter wave plate 137 can convert right circularly polarized light into light that is polarized in the y-direction and the quarter wave plate 137 can convert left circularly polarized light into light that is polarized in the x-direction. The third filter stack 135 also includes a polarization dependent beam splitter 138 that transmits light polarized in a first direction and reflects light polarized in a second direction that is orthogonal or transverse to the first direction. For example, the polarization dependent beam splitter 138 can reflect light polarized in the y-direction and transmit light polarized in the x-direction. Some embodiments of the third filter stack 135 also include a linear polarizer 139 that transmits linearly polarized light. For example, the linear polarizer 139 can transmit light polarized in the x-direction.

Some embodiments of the third filter stack 135 are bonded to the refractive beam splitting lens system 125. For example, the quarter wave plate 137 can be laminated to the planar surface 131 of the refractive convex lens 127. Bonding the third filter stack 135 to the refractive beam splitting lens system 125 has a number of advantages, including reduced size of the optical system 100, a larger field-of-view, a reduced number of Fresnel reflections (or ghost images) produced at optical surfaces in the optical system 100, and the like. In other embodiments, the third filter stack 135 is separated from the refractive beam splitting lens system 125 by an air gap. Furthermore, as discussed herein, some embodiments of the third filter stack 135 are disposed between the refractive planar-convex lens 127 and the refractive planar-concave lens 128.

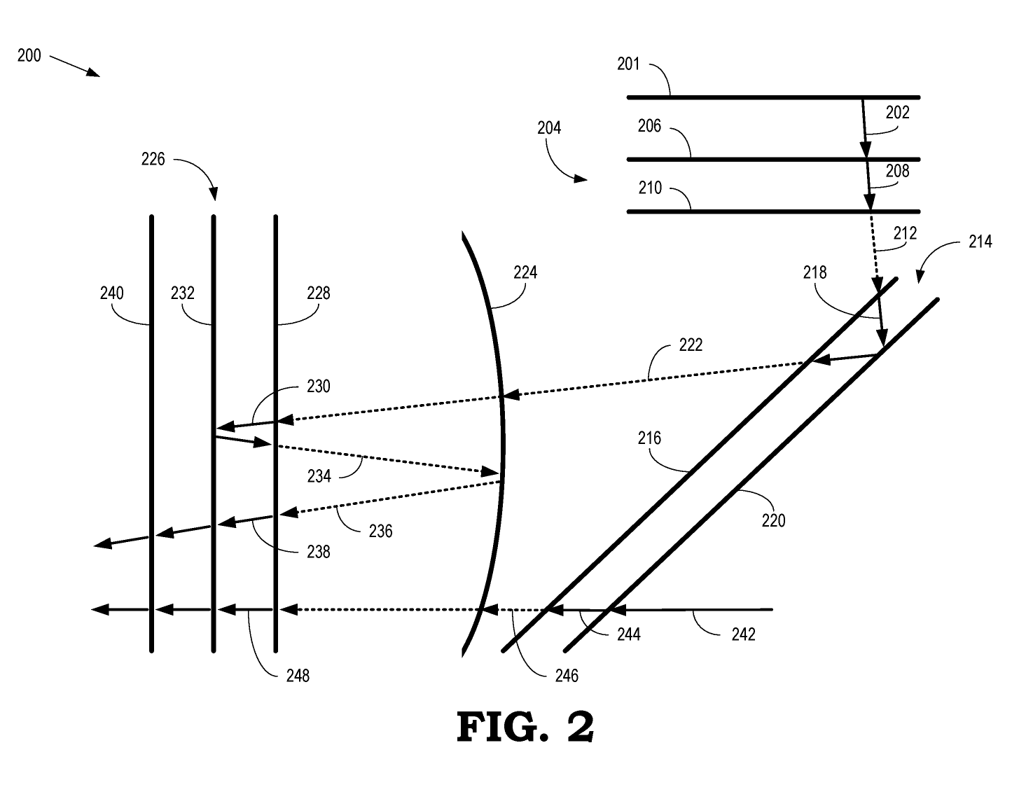

FIG. 2 is a diagram of a second example of an optical system 200 that illustrates folding of an optical path of a light ray generated by a display 201 and combination of the light ray with external light according to some embodiments. The optical system 200 represents some embodiments of the optical system 100 shown in FIG. 1. Initially, a light ray 202 that emerges from the display 201 is unpolarized or partially polarized. The light ray 202 is directed onto a first filter stack 204 that includes a linear polarizer 206, which converts the light ray 202 into a linearly polarized light ray 208. For example, the light ray 208 can be polarized in the y-direction. A quarter wave plate 210 converts the linearly polarized light ray 208 into a light ray 212 having a first circular polarization. For example, the quarter wave plate 210 can convert the light ray 208 from a linear polarization in the y-direction to the light ray 212 that is right circularly polarized.

A second filter stack 214 receives the light ray 212. The second filter stack 214 includes a quarter wave plate 216 that converts the circularly polarized light ray 212 into linear polarized light ray 218. For example, the quarter wave plate 216 can convert the right circularly polarized light ray 212 into a linear polarized light ray 218 that is polarized in the y-direction. A polarization dependent beam splitter 220 in the second filter stack 214 reflects light in one linear polarization and transmit light in the orthogonal linear polarization. For example, the polarization dependent beam splitter 220 reflects the linear polarized light ray 218, which then passes through the quarter wave plate 216 and is converted into a circularly polarized light ray 222. For example, the quarter wave plate 216 can convert the reflected linear polarized light ray 218 from a polarization in the y-direction to right circular polarization. The second filter stack 214 is angled relative to the display 201 to direct reflected light received from the display 201 on to a refractive beam splitting lens system 224, which is implemented using some embodiments of the refractive beam splitting lens system 125 shown in FIG. 1.

The refractive beam splitting lens system 224 transmits a portion of the circularly polarized light ray 222, which is then refracted within the refractive beam splitting lens system 224 before being provided to a third filter stack 226. The third filter stack 226 includes a quarter wave plate 228, which converts the circularly polarized light ray 222 to a linearly polarized light ray 230. For example, the quarter wave plate 228 can convert a right circularly polarized light ray 222 into a light ray 230 that is linearly polarized in the y-direction. The light ray 230 is reflected by a polarization dependent beam splitter 232 and converted to a circularly polarized light ray 234 by the quarter wave plate 228. For example, the light ray 230 can be converted from linear polarization in the y-direction to a light ray 234 having right circular polarization. The light ray 234 is refracted by the refractive beam splitting lens system 224 and a portion of the light ray 234 reflects from the refractive beam splitting lens system 224. Reflection reverses the circular polarization of the light ray 234, e.g., reflection converts the light ray 234 to a left circularly polarized light ray 236. The quarter wave plate 228 converts the circularly polarized light ray 236 into a linearly polarized light ray 238. For example, the left circular polarization of the light ray 236 is converted into linear polarization of the light ray 238 in the x-direction. The polarization dependent beam splitter 232 and a linear polarizer 240 transmit the linearly polarized light ray 238.

The optical system 200 transmits a portion of an external light ray 242, which can be unpolarized or partially polarized. In the illustrated embodiment, the external light ray 242 is filtered by the polarization dependent beam splitter 220 to generate a linear polarized light ray 244. For example, the light ray 244 can be polarized in the x-direction. The quarter wave plate 216 converts the light ray 244 into a circularly polarized light ray 246. For example, the light ray 244 can be converted from linear polarization in the x-direction to a left circularly polarized light ray 246. The refractive beam splitting lens system 224 transmits a portion of the circularly polarized light ray 246, which is then refracted within the refractive beam splitting lens system 224 before being provided to the third filter stack 226. The circularly polarized light ray 246 is then converted to linear polarized light ray 248 by the quarter wave plate 228. For example, the left circularly polarized light ray 246 can be converted into a light ray 248 that is polarized in the x-direction. The polarization dependent beam splitter 232 and the linear polarizer 240 transmit the linearly polarized light ray 248.

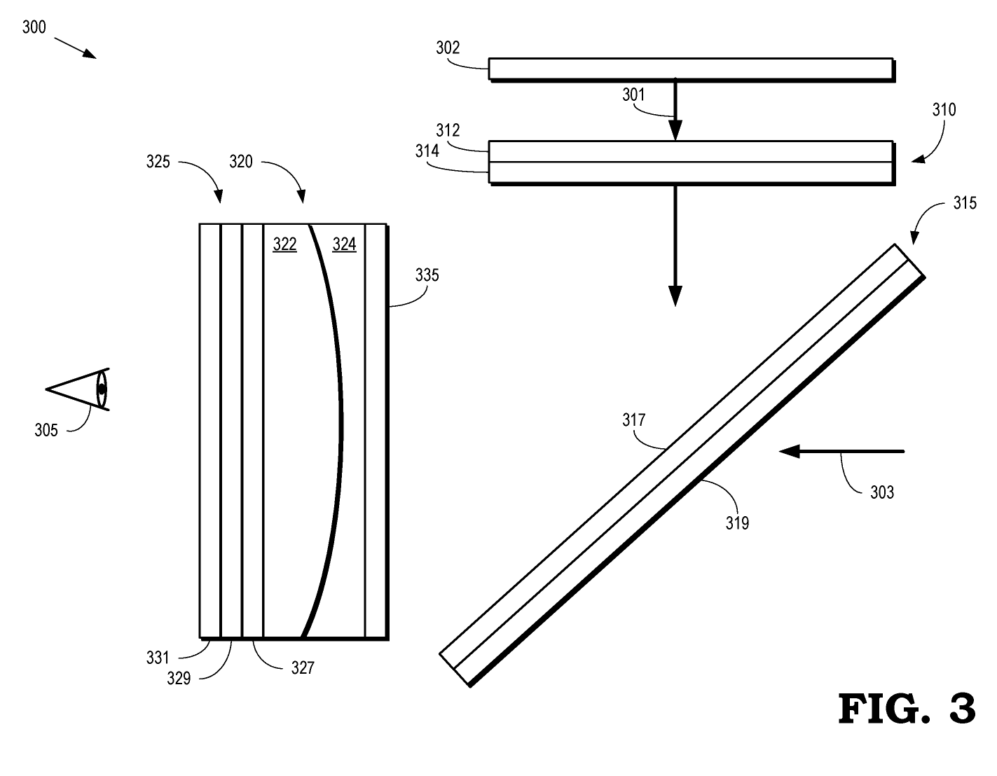

FIG. 3 is a diagram of a third example of an optical system 300 that combines light 301 received from a display 302 with external light 303 to provide substantially parallel light rays that represent an augmented reality image to an eye 305 of a user according to some embodiments. The optical system 300 includes a first filter stack 310 that includes a linear polarization filter 312 and a quarter wave plate 314. The optical system 300 also includes a second filter stack 315 that includes a polarization dependent beam splitter 317 and a linear polarizer 319. A refractive beam splitting lens system 320 includes a plano-convex refractive lens 322 and a plano-concave refractive lens 324. The optical system 300 also includes a third filter stack 325 that is formed of a quarter wave plate 327, a polarization dependent beam splitter 329, and a linear polarizer 331.

As discussed herein, the second filter stack 315 is oriented at an angle with respect to the first filter stack 310 and the refractive beam splitting lens system 320. For example, the second filter stack 315 can be oriented at a 45° angle with respect to the first filter stack 310 and the refractive beam splitting lens system 320. Orienting the second filter stack 315 at an angle with respect to the first filter stack 310 and the refractive beam splitting lens system 320 allows the second filter stack 315 to direct light received from the first filter stack 310 towards the refractive beam splitting lens system 320. The optical system 300 differs from the optical system 100 shown in FIG. 1 because a quarter wave plate 335 is laminated to a planar surface of the plano-concave refractive lens 324, instead of being implemented as an integral part of the second filter stack 315.

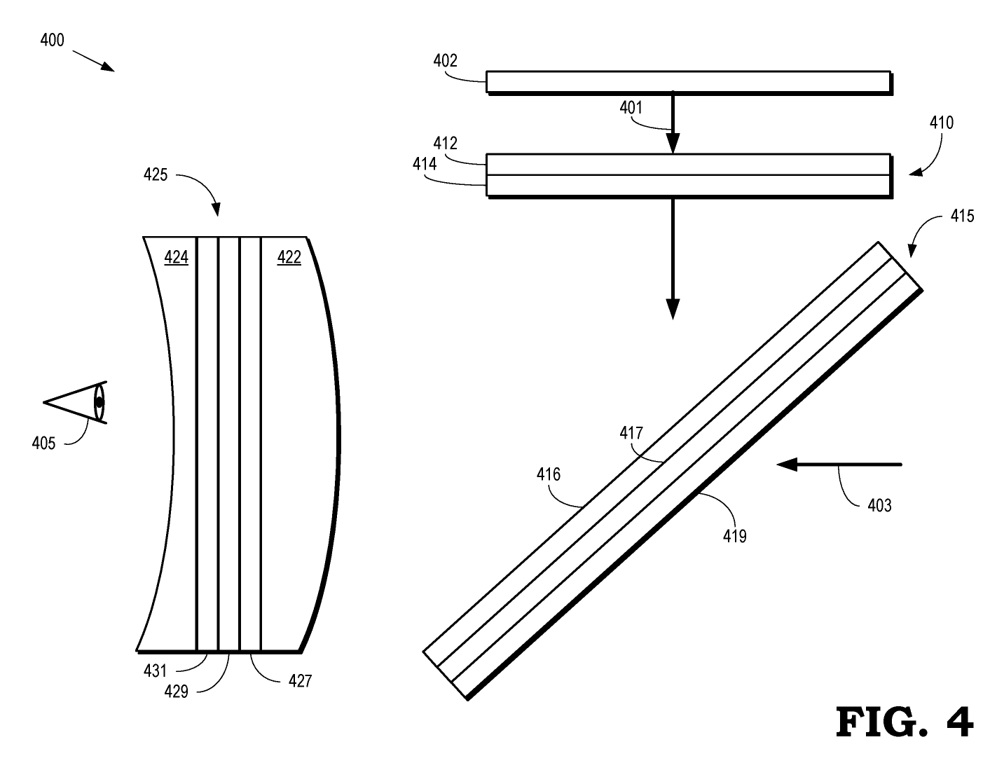

FIG. 4 is a diagram of a fourth example of an optical system 400 that combines light 401 received from a display 402 with external light 403 to provide substantially parallel light rays that represent an augmented reality image to an eye 405 of a user according to some embodiments. The optical system 400 includes a first filter stack 410 that includes a linear polarization filter 412 and a quarter wave plate 414. The optical system 400 also includes a second filter stack 415 that includes a quarter wave plate 416, a polarization dependent beam splitter 417 and a linear polarizer 419. A refractive beam splitting lens system includes a plano-convex refractive lens 422 and a plano-concave refractive lens 424. The optical system 400 also includes a third filter stack 425 that is formed of a quarter wave plate 427, a polarization dependent beam splitter 429, and a linear polarizer 431.

As discussed herein, the second filter stack 415 is oriented at an angle with respect to the first filter stack 410 and the refractive beam splitting lens system 420. For example, the second filter stack 415 can be oriented at a 45° angle with respect to the first filter stack 410 and the refractive beam splitting lens system. Orienting the second filter stack 415 at an angle with respect to the first filter stack 410 and the refractive beam splitting lens system 420 allows the second filter stack 415 to direct light received from the first filter stack 410 towards the refractive beam splitting lens system 420. The optical system 400 differs from the optical system 100 shown in FIG. 1 and the optical system 300 shown in FIG. 3 because the plano-convex refractive lens 422 is separated from the plano-concave refractive lens 424. In the illustrated embodiment, the third filter stack 425 is disposed between the plano-convex refractive lens 422 and the plano-concave refractive lens 424. For example, the quarter wave plate 427 can be laminated to a planar surface of the plano-convex refractive lens 422 and the linear polarizer 431 can be laminated to a planar surface of the plano-concave refractive lens 424.

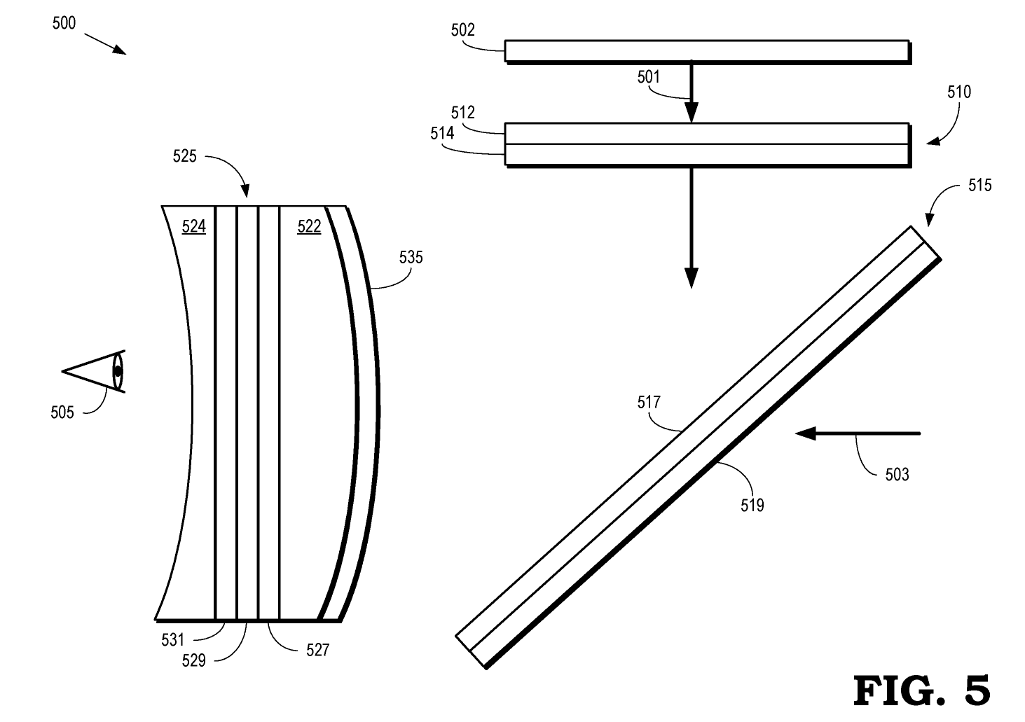

FIG. 5 is a diagram of a fifth example of an optical system 500 that combines light 501 received from a display 502 with external light 503 to provide substantially parallel light rays that represent an augmented reality image to an eye 505 of a user according to some embodiments. The optical system 500 includes a first filter stack 510 that includes a linear polarization filter 512 and a quarter wave plate 514. The optical system 500 also includes a second filter stack 515 that includes a polarization dependent beam splitter 517 and a linear polarizer 519. A refractive beam splitting lens system includes a plano-convex refractive lens 522 and a plano-concave refractive lens 524. The optical system 500 also includes a third filter stack 525 that is formed of a quarter wave plate 527, a polarization dependent beam splitter 529, and a linear polarizer 531.

As discussed herein, the second filter stack 515 is oriented at an angle with respect to the first filter stack 510 and the refractive beam splitting lens system. For example, the second filter stack 515 can be oriented at a 45° angle with respect to the first filter stack 510 and the refractive beam splitting lens system. Orienting the second filter stack 515 at an angle with respect to the first filter stack 510 and the refractive beam splitting lens system 520 allows the second filter stack 515 to direct light received from the first filter stack 510 towards the refractive beam splitting lens system 520. The optical system 500 differs from the optical system 100 shown in FIG. 1 and the optical system 300 shown in FIG. 3 because the plano-convex refractive lens 522 is separated from the plano-concave refractive lens 524. In the illustrated embodiment, the third filter stack 525 is disposed between the plano-convex refractive lens 522 and the plano-concave refractive lens 524. For example, the quarter wave plate 527 can be laminated to a planar surface of the plano-convex refractive lens 522 and the linear polarizer 531 can be laminated to a planar surface of the plano-concave refractive lens 524. The optical system 500 also differs from the optical system 100 shown in FIG. 1 and the optical system 400 shown in FIG. 4 because a quarter wave plate 535 is laminated to a concave surface of the plano-concave refractive lens 524, instead of being implemented as an integral part of the second filter stack 515.

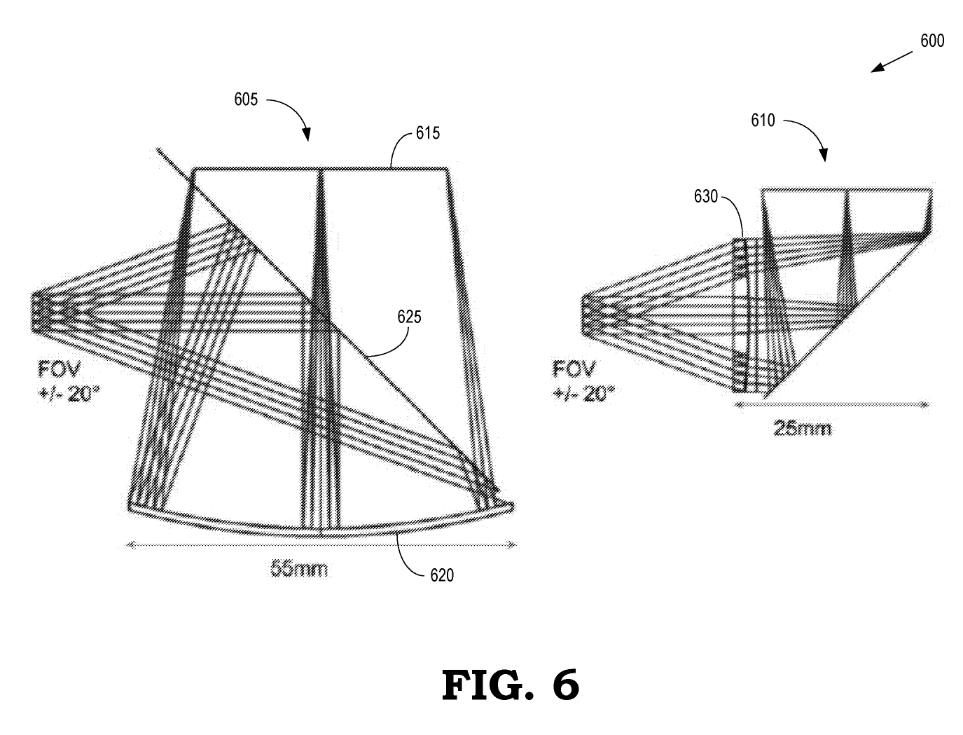

FIG. 6 is a comparison 600 of a conventional birdbath lens system 605 and a lens system 610 that includes a refractive beam splitting lens system according to some embodiments. In the illustrated embodiment, the conventional birdbath lens system 605 and the lens system 610 provide the same field-of-view (20°) to users of the systems. However, the conventional birdbath lens system 605 implements a display 615 and a reflective concave lens 620 that are aligned along an axis that is perpendicular to a line of sight from the user to an external light source. A beam splitter 625 is disposed between the display 615 and the reflective concave lens 620. The element that provides the optical power, the reflective concave lens 620, is therefore disposed much further from the user than the element that provides optical power in the lens system 610, i.e., the refractive beam splitting lens system 630. Consequently, the dimensions of the conventional birdbath lens system 605 are more than twice as large as the dimensions of the lens system 610, even though both provide the same field-of-view to the user.

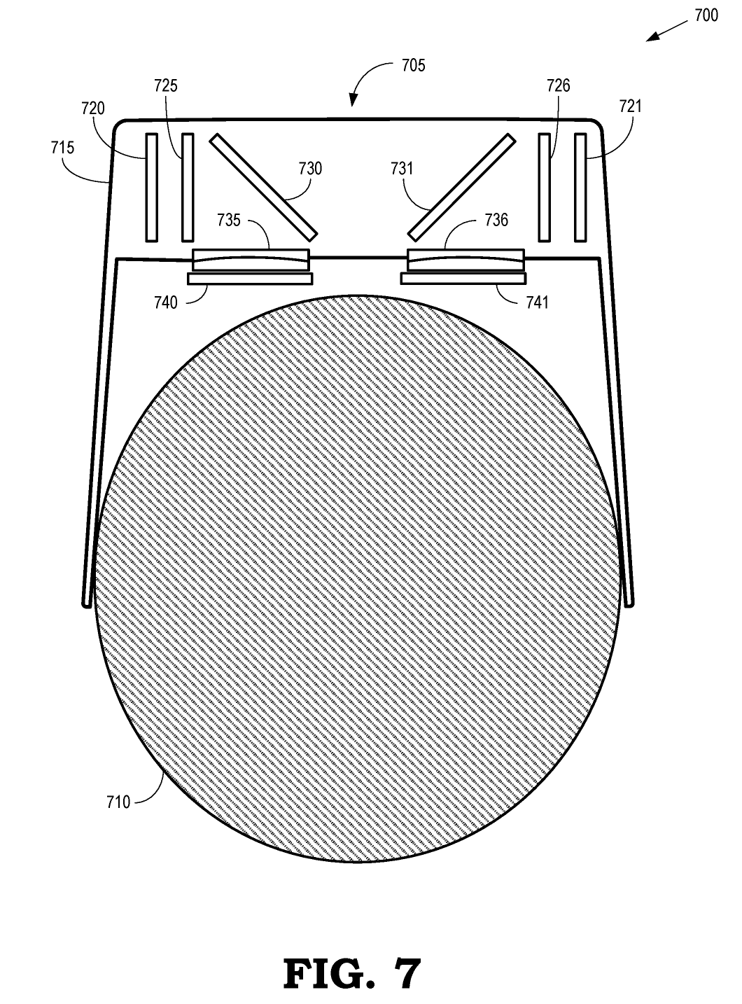

FIG. 7 illustrates a display system 700 that includes an electronic device 705 configured to provide augmented reality functionality via a display according to some embodiments. The illustrated embodiment of the electronic device 705 can include a portable user device, such as an HMD, a tablet computer, computing-enabled cellular phone (e.g., a “smartphone”), a notebook computer, a personal digital assistant, a gaming console system, and the like. In other embodiments, the electronic device 705 can include a fixture device, such as medical imaging equipment, a security imaging sensor system, an industrial robot control system, a drone control system, and the like. For ease of illustration, the electronic device 705 is generally described herein in the example context of an HMD system; however, the electronic device 705 is not limited to these example implementations.

The electronic device 705 is shown in FIG. 7 as being mounted on a head 710 of a user. As illustrated, the electronic device 705 includes a housing 715 that includes displays 720, 721 that generate images for presentation to the user. The displays 720, 721 can be implemented using some embodiments of the display 102 shown in FIG. 1, the display 201 shown in FIG. 2, the display 302 shown in FIG. 3, the display 402 shown in FIG. 4, and the display 502 shown in FIG. 5. In the illustrated embodiment, the displays 720, 721 are used to display stereoscopic images to corresponding left eye and right eye.

Light generated by the displays 720, 721 is provided to corresponding first filter stacks 725, 726, which can be implemented using some embodiments of the first filter stack 110 shown in FIG. 1, the first filter stack 204 shown in FIG. 2, the first filter stack 310 shown in FIG. 3, the first filter stack 410 shown in FIG. 4, and the first filter stack 510 shown in FIG. 5.

Second filter stacks 730, 731 are oriented to reflect light received from the first filter stacks 725, 726 on to corresponding refractive beam splitting lens systems 735, 736. The second filter stacks 730, 731 are also configured to transmit light received from external sources. The second filter stacks 730, 731 can be implemented using some embodiments of the second filter stack 120 shown in FIG. 1, the second filter stack 214 shown in FIG. 2, the second filter stack 315 shown in FIG. 3, the second filter stack 415 shown in FIG. 4, and the second filter stack 515 shown in FIG. 5. The refractive beam splitting lens systems 735, 736 can be implemented using some embodiments of the refractive beam splitting lens system 125 shown in FIG. 1, the refractive beam splitting lens system 224 shown in FIG. 2, the refractive beam splitting lens system 320 shown in FIG. 3, and the refractive beam splitting lens systems shown in FIGS. 4 and 5.

Light from the refractive beam splitting lens systems 735, 736 is provided to corresponding third filter stacks 740, 741, which can be implemented using some embodiments of the third filter stack 135 shown in FIG. 1, the third filter stack 226 shown in FIG. 2, the third filter stack 325 shown in FIG. 3, the third filter stack 425 shown in FIG. 4, and the third filter stack 525 shown in FIG. 5. As discussed herein, some embodiments of the third filter stacks 740, 741 are disposed intermediate a plano-convex refractive lens and a plano-concave reflective lens that are used to implement the refractive beam splitting lens systems 735, 736.

Optical systems that provide augmented reality using refractive beam splitting lens systems, as discussed herein, have a number of advantages over conventional optical systems. Placing the refractive beam splitting lens system closer to the eye of the user increases the potential field-of-view (up to 80°) and reduces the overall size of the optical system. For example, a total track length and a head mounted device that implements augmented reality using the refractive beam splitting lens system can be less than 30 mm. Optical systems that implement the refractive beam splitting lens systems are also able to reduce or eliminate optical see-through distortion and display distortion. Optical aberrations can be reduced because the curved surfaces in the refractive beam splitting lens system provides either single reflection optical power or single refraction power, which allows a user to resolve smaller display pixels. Some embodiments of optical systems that implement the refractive beam splitting lens system can provide a larger eye box and reduce “pupil swimming.” Spherical aberration, chromatic aberration, astigmatism, and coma can also be reduced by implementing the refractive beam splitting lens system described herein. Furthermore, the positive refractive elements in the refractive beam splitting lens system can balance the field curvature of the reflective elements of the refractive beam splitting lens system.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. An apparatus comprising:
a first filter stack configured to convert light received from a display to a first circular polarization;
a second filter stack configured to convert light received from external sources to a second circular polarization;
a third filter stack configured to reflect light having the first circular polarization and transmit light having the second circular polarization; and
a refractive beam splitting lens configured to transmit light received from the second filter stack to the third filter stack, wherein the second filter stack is oriented to reflect light received from the first filter stack onto the refractive beam splitting lens.

2. The apparatus of claim 1, wherein the first filter stack comprises:
a first linear polarizer to convert light to a first linear polarization; and
a first quarter wave plate to convert the light from the first linear polarization to the first circular polarization.

3. The apparatus of claim 2, wherein the second filter stack comprises:
a second quarter wave plate to convert the first circular polarization to the first linear polarization; and
a first polarization dependent beam splitter to reflect light having the first linear polarization and transmit light having a second linear polarization.

4. The apparatus of claim 3, wherein the third filter stack comprises:
a third quarter wave plate; and
a second polarization dependent beam splitter to reflect light having the first linear polarization and transmit light having the second linear polarization.

5. The apparatus of claim 4, wherein the refractive beam splitting lens comprises:
a refractive plano-convex lens having a convex beam splitting surface opposite a first planar surface; and
a refractive plano-concave lens having a concave surface opposite a second planar surface.

6. The apparatus of claim 5, wherein a first curvature of the convex beam splitting surface of the refractive plano-convex lens is complementary to a second curvature of the concave surface of the refractive plano-concave lens.

7. The apparatus of claim 5, wherein the third quarter wave plate is laminated to the second planar surface.

8. The apparatus of claim 5, wherein the second filter stack is deployed between the first planar surface of the refractive plano-convex lens and the second planar surface of the refractive plano-concave lens.

9. The apparatus of claim 8, wherein the third quarter wave plate is laminated to the convex beam splitting surface of the refractive plano-convex lens.

10. An apparatus comprising:
a first display to generate first images for presentation to a first eye of a user; and
a first optical system configured to combine light representative of the first images with light received from an external source for provision to the first eye, wherein the first optical system includes:
a first filter stack configured to convert light received from the first display to a first circular polarization;
a second filter stack configured to convert light received from the external source to a second circular polarization;
a third filter stack configured to reflect light having the first circular polarization and transmit light having the second circular polarization; and
a first refractive beam splitting lens configured to transmit light received from the second filter stack to the third filter stack, wherein the second filter stack is oriented to reflect light received from the first filter stack onto the first refractive beam splitting lens.

11. The apparatus of claim 10, wherein the first filter stack comprises:
a first linear polarizer to convert light to a first linear polarization; and
a first quarter wave plate to convert the light from the first linear polarization to the first circular polarization.

12. The apparatus of claim 11, wherein the second filter stack comprises:
a second quarter wave plate to convert the first circular polarization to the first linear polarization; and
a first polarization dependent beam splitter to reflect light having the first linear polarization and transmit light having a second linear polarization.

13. The apparatus of claim 12, wherein the third filter stack comprises:
a third quarter wave plate; and
a second polarization dependent beam splitter to reflect light having the first linear polarization and transmit light having the second linear polarization.

14. The apparatus of claim 13, wherein the refractive beam splitting lens comprises:
a refractive plano-convex lens having a convex beam splitting surface opposite a first planar surface; and
a refractive plano-concave lens having a concave surface opposite a second planar surface.

15. The apparatus of claim 14, wherein a first curvature of the convex beam splitting surface of the refractive plano-convex lens is complementary to a second curvature of the concave surface of the refractive plano-concave lens.

16. The apparatus of claim 14, wherein the third quarter wave plate is laminated to the second planar surface.

17. The apparatus of claim 14, wherein the second filter stack is deployed between the first planar surface of the refractive plano-convex lens and the second planar surface of the refractive plano-concave lens.

18. The apparatus of claim 17, wherein the third quarter wave plate is laminated to the convex beam splitting surface of the refractive plano-convex lens.

19. The apparatus of claim 10, further comprising:
a second display to generate second images for presentation to a second eye of the user; and
a second optical system configured to combine light representative of the second images with light received from the external source for provision to the second eye, wherein the second optical system includes:
a fourth filter stack configured to convert light received from the second display to the first circular polarization;
a fifth filter stack configured to convert light received from the external source to the second circular polarization;
a sixth filter stack configured to reflect light having the first circular polarization and transmit light having the second circular polarization; and
a second refractive beam splitting lens configured to transmit light received from the fifth filter stack to the sixth filter stack, wherein the fifth filter stack is oriented to reflect light received from the fourth filter stack onto the second refractive beam splitting lens.

20. The apparatus of claim 19, wherein the first eye is a left eye of the user and the second eye is a right eye of the user, and wherein the first and second images are stereoscopic images.

21. A method comprising:
converting, at a first filter stack, light received from a display to a first circular polarization;
reflecting, at a second filter stack, light having the first circular polarization onto a refractive beam splitting lens;
refracting, at the refractive beam splitting lens, the light in the first circular polarization and providing the light to a third filter stack;
reflecting, at the third filter stack, the light having the first circular polarization back to the refractive beam splitting lens;
reflecting, from a convex surface of the refractive beam splitting lens, the light having the first circular polarization so that the reflected light has a second circular polarization; and
transmitting, through the third filter stack, the reflected light having the second circular polarization and light having the second polarization that is received at the second filter stack from an external source.

22. The method of claim 21, wherein refracting the light comprises reflecting the light at the refractive beam splitting lens that comprises:
a refractive plano-convex lens having a convex beam splitting surface opposite a first planar surface; and
a refractive plano-concave lens having a concave surface opposite a second planar surface.
